(19) United States
(12) Patent Application Publication
(10) Pub. No.: US 2014/0010307 A1
(43) Pub. Date: Jan. 9, 2014

(54) METHOD OF AND APPARATUS FOR COMPLEXITY SCALABLE FRAME RATE UP-CONVERSION

(71) Applicants: Marat Ravilevich Gilmutdinov, Saint-Petersburg (RU); Anton Igorevich Veselvo, Saint-Petersburg (RU)

(72) Inventors: Marat Ravilevich Gilmutdinov, Saint-Petersburg (RU); Anton Igorevich Veselvo, Saint-Petersburg (RU)

(21) Appl. No.: 13/997,516

(22) PCT Filed: Dec. 30, 2011
(86) PCT No.: PCT/RU2011/001059

§ 371 Date: Jun. 24, 2013

(51) Int. Cl. H04N 7/36

(52) U.S. Cl. CPC H04N 19/00648
USPC 375/240.16

(57) ABSTRACT

A method includes performing a hierarchal motion estimation operation to generate an interpolated frame from a first frame and a second frame, the interpolated frame disposed between the first frame and the second frame, said hierarchal motion estimation including performing two or more process iterations, each iteration including: (a) performing an initial bilateral motion estimation operation on the first frame and the second frame to produce a motion field comprising a plurality of motion vectors, (b) performing a motion field refinement operation for the plurality of motion vectors, (c) performing an additional bilateral motion estimation operation on the first frame and the second frame and (d) repeating steps (b) through (c) until a stop criterion is encountered.

### BACKGROUND

Modern frame rate up-conversion (FRUC) schemes are generally based on temporal motion compensated frame interpolation (MCFI). An important challenge in this task is the calculation of the motion vectors reflecting true motion, the actual trajectory of an object's movement between successive frames. Typical FRUC schemes use block-matching based motion estimation (ME), whereby a result is attained through minimization of the residual frame energy, but unfortunately, it does not reflect true motion.

There may therefore exist a need for new approaches to frame rate up conversion.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a flow chart according an exemplary and non-limiting embodiment;

FIG. 2 is a flow chart according an exemplary and non-limiting embodiment;

FIG. 3 is a flow chart according an exemplary and non-limiting embodiment;

FIG. 4 is a flow chart according an exemplary and non-limiting embodiment;

FIG. 5 is an illustration of a sum of differences (SAD) processing on successive frames according to an exemplary and non-limiting embodiment;

FIGS. 6A-6B is an illustration of occlusion processing according to an exemplary and non-limiting embodiment;

FIG. 7 is a diagram of a device according to an exemplary and non-limiting embodiment;

### DETAILED DESCRIPTION

In accordance with various exemplary embodiments described herein, there is provided a method for enhanced complexity scalable frame rate up-conversion (FRUC), particularly 2× frame rate up-conversion, for video sequences.

Modern frame rate up-conversion schemes are largely based on temporal motion compensated frame interpolation (MCFI). One of the most important challenges in this task is the calculation of the motion vectors reflecting true motion which is the actual trajectory of the objects movement between successive frames. As noted above, typical FRUC schemes use block-matching based motion estimation (ME) to minimize the energy of residual frames and does not reflect true motion. In accordance with various exemplary and non-limiting embodiments there is described herein an iterative scheme that enables complexity scalability and utilizing a bilateral block-matching search. Such a methodology increases the accuracy of the calculated motion vectors at each iteration of motion detection. As described more fully below, an exemplary embodiment employs an iterative search while varying sizes of the image block comprising a portion of a frame.

In one exemplary embodiment, a process starts with a relatively large frame block size to find global motion within a frame and proceeds with smaller block sizes for local motion regions. To avoid the problems connected with holes resulting from occlusions on the interpolated frame, bilateral motion estimation is used. This significantly reduces the complexity of frame interpolation using the calculated motion vectors.

Typical block-matching motion estimation proceeds by matching a block in a present frame with a corresponding block in a previous frame as well with a corresponding block in a subsequent frame. In contrast, bilateral motion estimation (ME) proceeds by identifying a block having an associated motion vector in a computed interpolated and/or intermediate frame and comparing the identified block to similar blocks in both the preceding and following frames from which the interpolated frame was computed. Underlying bilateral motion estimation is the assumption that inter-frame motion is uniform and linear

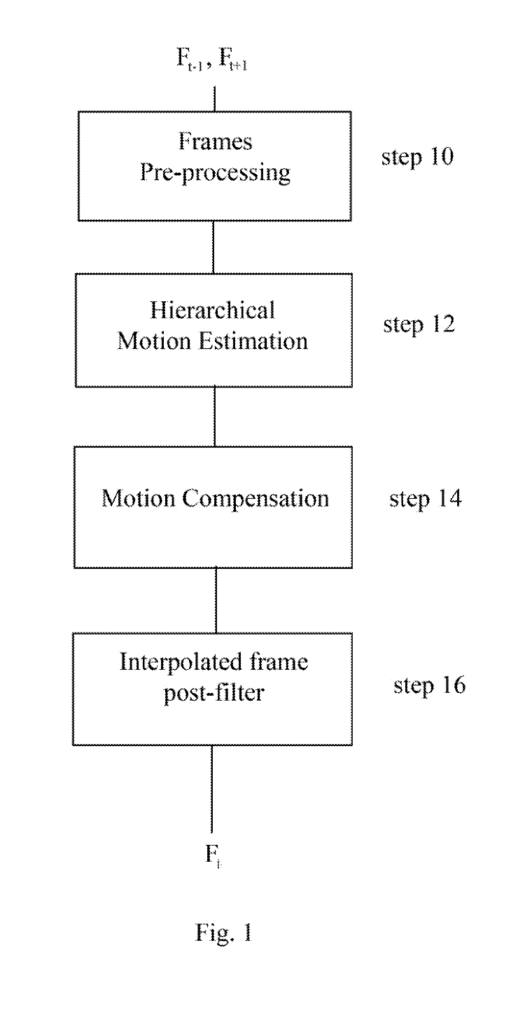

With reference to FIG. 1, there is illustrated a flow chart of an exemplary and non-limiting embodiment. Various steps discussed in abbreviated form are described in greater detail in U.S. patent application Ser. No. ______ to Gilmutdinov et al., filed ______, the contents of which is incorporated herein by reference.

Note that the inputs for the illustrated exemplary process are two successive frames Fₜ₋₁, Fₜ₊1 where t designates the intermediate position of an interpolated frame, Fₜ, that forms the output. In accordance with such an exemplary embodiment, computing and inserting an interpolated frame effectively doubles the number of frames in a file resulting in a 2× frame rate up-conversion. As would be evident to one skilled in the art, the process steps discussed herein may be applied to instances wherein frame interpolation may be repeated one or more times for different FRUC multiples.

At step 10, frame pre-processing is performed. Frame preprocessing may involve removing a black border as may be present in a frame or frames and expanding each frame to suit maximum block size. In an exemplary and non-limiting embodiment, the maximum block size is chosen to be a power of two (2). Frame expansion may be performed in any suitable manner. For example, frames may be padded to suit the block size. In an exemplary embodiment, the dimensions of a frame are evenly divisible by the block size. As used herein, a “frame” refers to a single image in a series of images forming a video sequence while “block” refers to a portion of a frame in which motion is detectable having an identifiable motion vector.

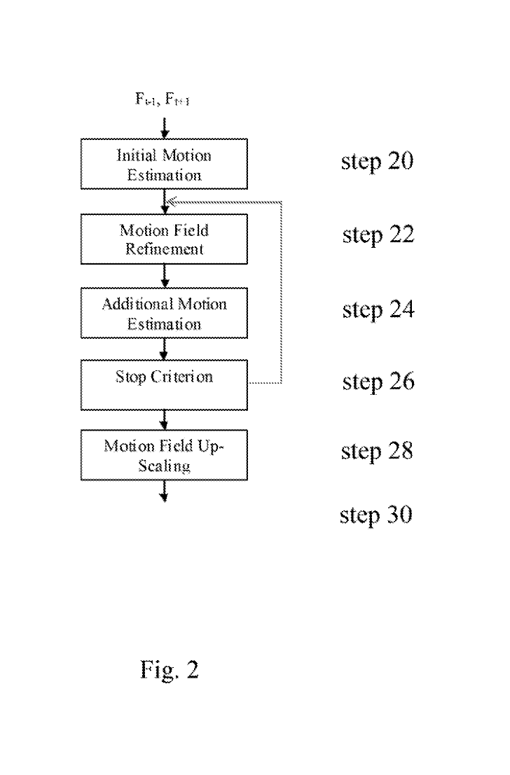

At step 12, hierarchical motion-estimation is performed. With reference to FIG. 2, there is illustrated an expanded flowchart illustrating the steps of hierarchical motion-estimation. Note that the input to step 20 is once again two successive frames Fₜ₋₁, Fₜ₊₁. At step 20, there is performed initial bilateral motion estimation.

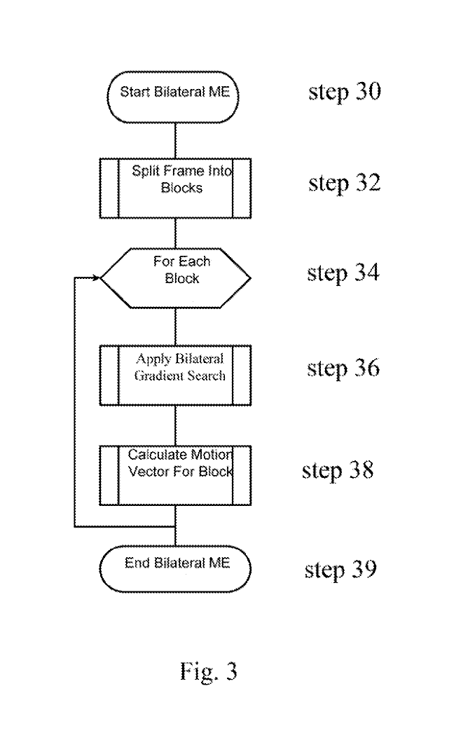

With reference to FIG. 3, there is illustrated in detail the initial bilateral motion estimation of step 20. At step 30, two successive frames Fₜ₋₁, Fₜ₊₁ form the input. Next, at step 32,

each frame, Fₜ₋₁, Fₜ₊₁, is split into blocks, B[N]. Then, at step 34, for each block, a bilateral gradient search is applied at step 36, and, at step 38, a motion vector is calculated for the block. Finally, at step 39, after all blocks B[N] have been processed, bilateral motion estimation ends.

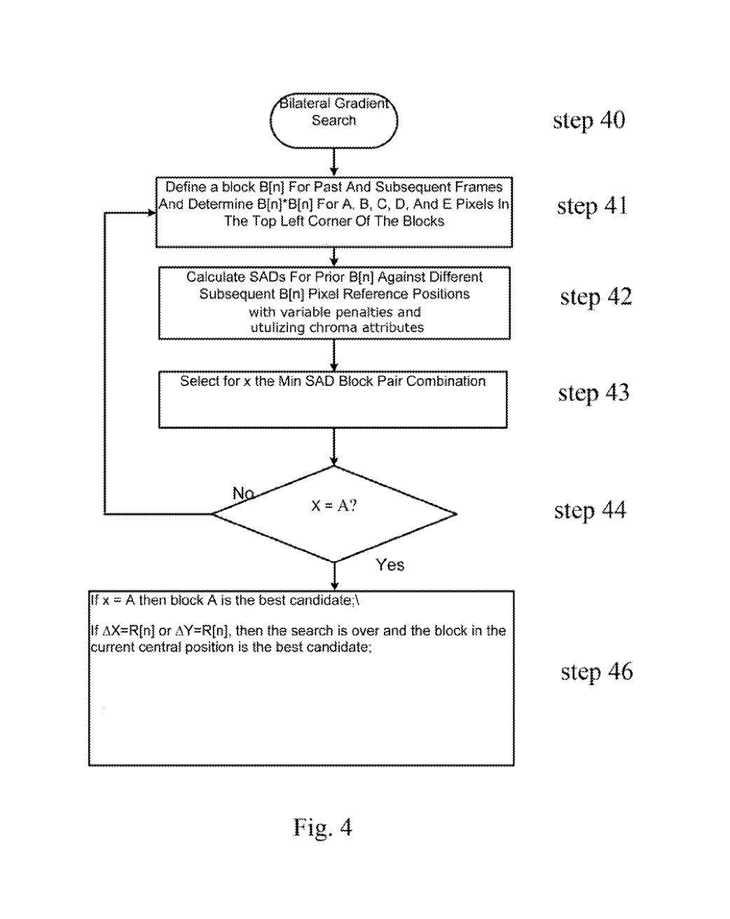

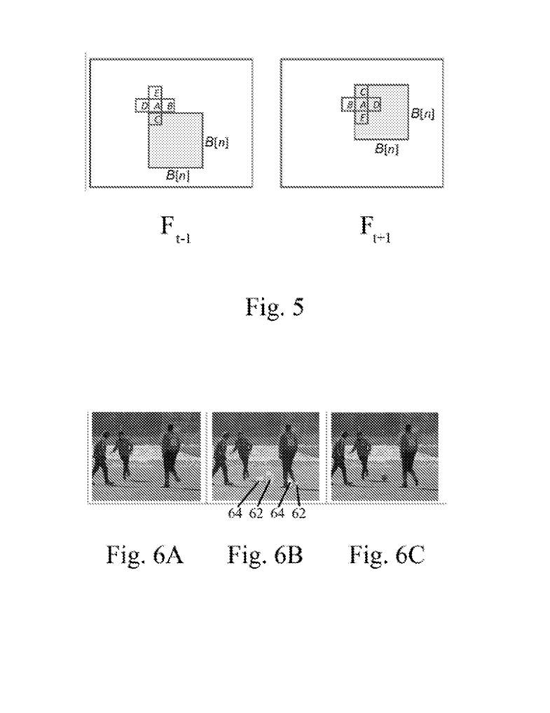

With reference to FIG. 4, there is illustrated and described in detail the bilateral gradient search of step 36. The illustrated gradient search returns an ME result that may be a motion field comprising two arrays: vₓ and v_{y} of integer values in the range (−R[n] to R[n]], where R[n] is a radius of the search on iteration number n. Both arrays have (W/B[n],H/B[n]) resolution, where B[n] is the block size on stage iteration number n, and W and H are expanded frame width and height.

At step 40, the bilateral gradient search begins. At step 41 a block B[n] is identified in each of frames Fₜ₋₁, Fₜ₊₁, wherein each block B[N] is located at an estimate of the position of a block B[N] in an intermediate frame, Fₜ. In the exemplary embodiment, let A, B, C, D and E be the neighbor pixels of the upper-left most pixel of a block in an interpolated base frame in either of frames Fₜ₋₁, Fₜ₊₁. The blocks B[n]*B[n] are constructed so that A, B, C, D and E pixels are in the top left corner of the blocks.

Next, at step 42, a sum of absolute differences (SAD) is calculated between blocks from the current interpolated frame and the five positions A, B, C, D and E from the prior and subsequent frame with penalties as described below. Having estimated the position for a block B[N] in a previous and subsequent frame, the SAD comparison acts to more finely determine the most accurate position of the block B[N] in both of frames Fₜ₋₁, Fₜ₊₁. This is accomplished by offsetting the estimated position of the blocks one pixel up, down, left and right and determining which offset results in a placement that most accurately captures the position of the block B[n} in both of frames Fₜ₋₁, Fₜ₊₁.

As noted above, in an exemplary embodiment the gradient search is performed with penalties. Specifically, there is employed a penalty value for motion vector vᵢ that depends on a current stage number and motion vector length:

Penaltyᵢ(|vᵢ|)=thr(|vᵢ|)*(A−stage)

where A—pre-defined threshold, stage—current stage number (also referred to as “stage number n”), thr(|vᵢ|)—pre-defined threshold depending on motion vector length |vᵢ|. Each stage is distinguishable by its attributes including, but not limited to, block size.

Calculation of sum of absolute differences between block base frames are calculated as follows:

$$\{ \begin{matrix}SAD ( A ) , SAD ( B ) + penalty [ n , B ] , SAD ( C ) + penalty [ n , C ] , \\ SAD ( D ) + penalty [ n , D ] , SAD ( E ) + penalty [ n , E ]\end{matrix} \}$$

where penalty[n,i]—the calculated penalty value for stage n and block i. In an exemplary embodiment, the SAD computation is performed using luma and chroma components:

$$SAD ( I ) = {\sum }_{i = 0}^{B [ N ] - 1} {\sum }_{j = 0}^{B [ N ] - 1} ( \begin{matrix}\vert Y ( {I}_{i , j}^{t - 1} ) - Y ( {I}_{i , j}^{t + 1} ) \vert + 2 * \vert Cb ( {I}_{i , j}^{t - 1} ) - Cb ( {I}_{i , j}^{t + 1} ) \vert + \\ 2 * \vert Cr ( {I}_{i , j}^{t - 1} ) - Cr ( {I}_{i , j}^{t + 1} ) \vert\end{matrix} )$$

Where

I—the block for which SAD is calculated (I can be A, B, C, D or E);

Y(I), Cb(I), Cr(I)—are luma and chroma components of the block;

I_{i,j}^{t-1}—pixel with coordinates i, j in block from frame t−1;

I_{i,j}^{t+1}—pixel with coordinates i, j in block from frame t+1.

Next, at step 43, there is selected the block pair with minimal SAD value. Specifically, there is selected one block from previous frame Fₜ₋₁ with motion vector (deltaX, deltaY) and one from future frame Fₜ₊₁ with motion vector (−deltaX, −deltaY) wherein motion vector (0,0) corresponds to the current block in interpolated frame Fₜ and the minimum value is computed as follows:

$$x = arg {min}_{i} ( SAD ( i ) )$$

Then, at step 44, a determination is made if x=A. If it is determined that x≠A, processing returns to step 41. Note that the exemplary process cannot loop and return step 41 indefinitely. Such looping is limited by frame borders enabling the identification of fast moving objects. In addition, parameter R[n] controls maximum of gradient search step (for complexity limitation). If, conversely, A=x then, the position of block A is the best candidate. Further, the additional conditions of step 46 act as stop conditions.

Specifically, if vₓ=R[n] or v_{y}=R[n] then the search is over and the block in the current central position is the best candidate.

If any of the blocks A, B, C, D, E cannot be constructed because it is out of border of the expanded frame then the SAD value for this block is set to the maximal possible positive value.

Motion vector (deltaX,deltaY) is calculated as the difference between position of current block I in interpolated frame Fₜ and position of the block in previous frame Fₜ₋₁. The difference between block I and a paired block from Fₜ₊₁ should be equal (−deltaX, −deltaY) according to bilateral motion estimation procedure (search is symmetric relatively to the position of I.) With continuing reference to FIG. 3, at step 38 a motion vector for the block B[N] in the interpolated frame is calculated and, at step 39, the initial bilateral motion estimation ends after all blocks have been processed.

With continued reference to FIG. 2, processing continues to step 22 whereat there is performed motion field refinement. Specifically, an iterative motion field refinement together with an additional search is performed. This procedure can be repeated several times depending on the selected stop criteria. In accordance with exemplary embodiments, stop criteria are based upon either of two conditions: (1) if a maximal predetermined number of iterations for current stage is achieved, or (2) if a percentage of the motion vectors affected by additional search is less than than some pre-defined threshold. As used herein, in the context of stop criteria, stage refers to a single progression from step 22 to step 26.

The motion field refinement of step 22 is employed to estimate the reliability of the motion vectors found on the initial bilateral motion estimation of step 20. This procedure is not necessarily fixed but should divide the motion vectors into two classes: reliable and unreliable. Any suitable motion vector reliability and/or classification scheme may be employed. From this, the derived reliable vectors are used in the next hierarchal ME stage, additional bilateral motion estimation at step 24, which allows for more accurate detection of true motion. Additional gradient searches associated with the bilateral motion estimation at step 24 start from unique points:

startX=x+vₓ^{k}

startY=y+v_{y}^{k}

where x and y—coordinated of the current block in interpolated frame Fₜ, vₓ^{k} and v_{y}^{k} are motion vectors from a candidate set which includes motion vectors for neighboring blocks and or for blocks on the same position as current block but in the previous hierarchy stages. The candidate set is formed as follows:

mvCand=union(mvNeig, mvPRevStage)

where mvNeig—a set of blocks neighboring the processed block, mvPRevStage—a set of blocks located in the same position as current block but in the previous stages, union(•)—operation of set union. mvNeig and mvPRevStage contain only those motion vectors which reliability is higher than the reliability of current motion vector. At step 26, a determination of whether or not either of the previously described stop conditions have been met. If one or both stop conditions have been met, processing proceeds to step 28. If neither stop conditions has been met, processing returns to step 22.

At step 28, motion field up-sampling is performed whereby the ME motion vector fields are up-scaled for the next ME iteration (if there is a “next” iteration). Any suitable known processes may be used for this step.

Depending on N, the number of hierarchal motion estimation iterations that are to be performed, an additional iteration may be undertaken, once again starting at step 20. Alternatively, if the N iterations have been completed, then at step 14 in FIG. 1, the process proceeds to perform a bilateral motion compensation (MC) operation at step 14.

Motion compensation may be done in any suitable way. For example, an overlapped block motion compensation (OBMC) procedure may be used to construct the interpolated frame. Overlapped block motion compensation (OBMC) is generally known and is typically formulated from probabilistic linear estimates of pixel intensities, given that limited block motion information is generally available to the decoder. In some embodiments, OBMC may predict the current frame of a sequence by re-positioning overlapping blocks of pixels from the previous frame, each weighted by some smooth window. Under favorable conditions, OBMC may provide reductions in prediction error, even with little (or no) change in the encoder's search and without extra side information. Performance can be further enhanced with the use of state variable conditioning in the compensation process.

Lastly, at step 16, there is applied an interpolated frame post-filter comprising the detection of occlusions and post processing of the detected occlusions. In an exemplary and non-limiting embodiment there are detected two types of artifacts: objects duplication and disappearing. These artifacts appear due to the existence of such called holes and occlusions in motion for key frames. Detection is based on conversion of bilateral motion vectors (coming from the interpolated frame) to unidirectional motion vectors (coming from key frames). As used herein “key frames” refer to the frames immediately preceding and following an interpolated frame. A histogram of unidirectional motion vectors in the key frames shows the number of motion vectors coming from the separate pixels. Groups of edge pixels with no motion vectors coming from elsewhere and groups of edge pixels with more than one incoming vector may produce visual artifacts, specifically, objects disappearing or objects duplicating, respectively. In accordance with an exemplary embodiment, detection should be applied to both key frames.

The formal description of the algorithm for frame Fₜ₋₁ (key frame from the past) is given below.

Calculate histogram of unidirectional motion vectors

pixMvNist_{i,j=|{(}k,l):(k,l)−(vₓ^{k,l},v_{y}^{k,l})=(i,j)}|

where i= 1̅,̅H̅, i= 1̅,̅W̅

H and W—frame height and width correspondingly;

(vₓ^{k,l}, v_{y}^{k,l})—motion vector for pixel (k,l) in the interpoloated frame

|•|—an operation of taking the number of couples (i, j) in a set

Calculate a map of holes and occlusions:

$${map}_{i , j} = \{ \begin{matrix}0 , if {pixMvHist}_{i , j} == 0 ( hole ) \\ 1 , if {pixMvHist}_{i , j} == 1 ( no artifact ) \\ 2 , otherwise ( occlusion )\end{matrix}$$

Calculation of Sobel metric E for key frame.

Calculate map of edge pixels for key frame using Sobel metric:

$${E}_{i , j} = \{ \begin{matrix}1 , if {E}_{i , j} > thrEdge \\ 0 , otherwise\end{matrix}$$

where thrEdge—pre-defined threshold. Refine the map of holes and occlusions using information about edges. Split the map into M×M blocks and for every block do:

$$nEdges = {\sum }_{k - 0}^{M - 1} {\sum }_{l - 0}^{M - 1} {E}_{x + k , y + l}$$

for k=0, 1, . . . , M−1; l=0, 1, . . . , M−1

Map_{x+k, y+}=1 if nEdges<thrEdgeBlock

where thrEdgeBlock—pre-defined threshold, x and y—coordinates of the top left pixel of the block.

With reference to FIGS. 6A-6B, there is illustrated various embodiments of the described occlusion detection. In FIG. 6A there is illustrated an exemplary embodiment of an interpolated frame without post-filter processing. FIG. 6B illustrates an exemplary embodiment of an interpolated frame with detected holes 62 and occlusions 64. FIG. 6C illustrates an exemplary embodiment of an interpolated frame with post-filter processing 16 as described above. The holes 62 regions can be corrected by a simple unidirectional search.

As is evident from the descriptions above, exemplary and non-limiting embodiments disclosed herein provide a scalable frame interpolation scheme based on hierarchical bilateral motion estimation. There is further provided bilateral gradient searching using chroma components data for SAD calculations as well as adaptive penalty calculations for each motion vector. Further, various exemplary embodiments employ iterative refinement and additional searching with an automatically calculated number of iterations per stage when performing up-scaling. In various other exemplary embodiments, there is demonstrated artifact detection and post-processing in the computed interpolated frame.

In addition to the exemplary embodiments described above, in accordance with an exemplary and non-limiting embodiment described above, prior to step 10 in FIG. 1, there is employed an a priori detector (before the interpolation) to detect changes in scenes in the video. Similarly, after step 16, there may be employed an a posteriori scene change detector(after the interpolation).

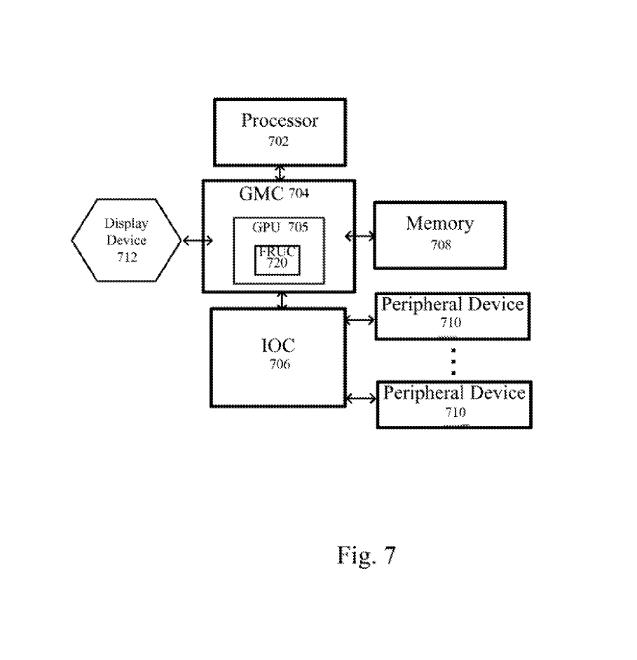

FIG. 7 shows a portion of an exemplary computing system for performing various exemplary embodiments discussed above. It comprises a processor 702 (or central processing unit “CPU”), a graphics/memory controller (GMC) 704, an input/output controller (IOC) 706, memory 708, peripheral devices/ports 710, and a display device 712, all coupled together as shown. The processor 702 may comprise one or more cores in one or more packages and functions to facilitate central processing tasks including executing one or more applications.

The GMC 704 controls access to memory 708 from both the processor 702 and IOC 706. It also comprises a graphics processing unit 705 to generate video frames for application(s) running in the processor 702 to be displayed on the display device 712. The GPU 705 comprises a frame-rate up-converter (FRUC) 720, which may be implemented as discussed herein.

The IOC 706 controls access between the peripheral devices/ports 710 and the other blocks in the system. The peripheral devices may include, for example, peripheral chip interconnect (PCI) and/or PCI Express ports, universal serial bus (USB) ports, network (e.g., wireless network) devices, user interface devices such as keypads, mice, and any other devices that may interface with the computing system.

The FRUC 720 may comprise any suitable combination of hardware and or software to generate higher frame rates. For example, it may be implemented as an executable software routine, e.g., in a GPU driver, or it may wholly or partially be implemented with dedicated or shared arithmetic or other logic circuitry. It may comprise any suitable combination of hardware and/or software, implemented in and/or external to a GPU to up-convert frame rate.

Some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. The right is hereby expressly reserved to file additional applications to pursue patents for subject matter that has been disclosed and enabled but not claimed in the present application.

What is claimed is:

1. A method comprising:
performing a hierarchal motion estimation operation to generate an interpolated frame from a first frame and a second frame, the interpolated frame disposed between the first frame and the second frame, said hierarchal motion estimation comprising performing two or more process iterations, each iteration comprising:
(a) performing an initial bilateral motion estimation operation on the first frame and the second frame to produce a motion field comprising a plurality of motion vectors;
(b) performing a motion field refinement operation for the plurality of motion vectors;
(c) performing an additional bilateral motion estimation operation on the first frame and the second frame; and
(d) repeating steps (b) through (c) until a stop criterion is encountered.

2. The method of claim 1 wherein the stop criteria comprises having repeated steps (b) through (c) a predefined number of times.

3. The method of claim 1 wherein the stop criteria comprises a percentage of the plurality of motion vectors affected by repeating steps (b) through (c) is less than a predefined threshold.

4. The method of claim 1 wherein at least one of the initial bilateral motion estimation operation and the additional bilateral motion estimation operation comprises a bilateral gradient search.

5. The method of claim 4 wherein the bilateral gradient search utilizes at least one chroma component of the first frame and the second frame.

6. The method of claim 4 wherein the bilateral gradient search utilizes a sum of differences (SAD) operation between the interpolated frame and at least one of the first frame and the second frame.

7. The method of claim 6 wherein the SAD incorporates an adaptive penalty.

8. The method of claim 7 wherein a value of the adaptive penalty depends upon a stage value and a motion vector length.

9. The method of claim 1 further comprising performing occlusion detection on the generated interpolated frame to detect one or more occlusions.

10. The method of claim 9 further comprising performing post processing of the one or more occlusions.

11. An article of manufacture comprising:
a computer readable medium having stored thereon instructions which, when executed by a processor, cause the processor to:
perform a hierarchal motion estimation operation to generate an interpolated frame from a first frame and a second frame, the interpolated frame disposed between the first frame and the second frame, said hierarchal motion estimation comprising performing two or more process iterations, each iteration comprising:
(a) performing an initial bilateral motion estimation operation on the first frame and the second frame to produce a motion field comprising a plurality of motion vectors;
(b) perform a motion field refinement operation for the plurality of motion vectors;
(c) performing an additional bilateral motion estimation operation on the first frame and the second frame; and
(d) repeating steps (b) through (c) until a stop criterion is encountered.

12. The article of manufacture of claim 11 wherein the stop criteria comprises having repeated steps (b) through (c) a predefined number of times.

13. The article of manufacture of claim 11 wherein the stop criteria comprises a percentage of the plurality of motion vectors affected by repeating steps (b) through (c) is less than a predefined threshold.

14. The article of manufacture of claim 11 wherein at least one of the initial bilateral motion estimation operation and the additional bilateral motion estimation operation comprises a bilateral gradient search.

15. The article of manufacture of claim 14 wherein the bilateral gradient search utilizes at least one chroma component of the first frame and the second frame.

16. The article of manufacture of claim 14 wherein the bilateral gradient search utilizes a sum of differences (SAD) operation between the interpolated frame and at least one of the first frame and the second frame.

17. The article of manufacture of claim 16 wherein the SAD incorporates an adaptive penalty.

18. The article of manufacture of claim 17 wherein a value of the adaptive penalty depends upon a stage value and a motion vector length.

19. The article of manufacture of claim 11 wherein the processor is further caused to perform occlusion detection on the generated interpolated frame to detect one or more occlusions.

20. The article of manufacture of claim 19 wherein the processor is further caused to perform post processing of the one or more occlusions.
